(19) United States
(12) Patent Application Publication
(10) Pub. No.: US 2016/0121576 A1
(43) Pub. Date: May 5, 2016

(54) ELECTROCONDUCTIVE PRESSURE-SENSITIVE ADHESIVE CUSHIONING

(71) Applicant: NITTO DENKO CORPORATION, Osaka (JP)

(72) Inventors: Shu SASAKI, Osaka (JP); Makoto SAITOU, Osaka (JP); Kiyoaki KODAMA, Osaka (JP); Masato FUJITA, Osaka (JP)

(73) Assignee: NITTO DENKO CORPORATION, Osaka (JP)

(21) Appl. No.: 14/927,870

(22) Filed: Oct. 30, 2015

(30) Foreign Application Priority Data
Nov. 4, 2014 (JP) 2014-224509

(51) Int. Cl. B32B 5/18; B32B 15/08; B32B 27/06; B32B 5/02

(52) U.S. Cl. CPC B32B 5/18; B32B 5/022; B32B 15/08; B32B 27/065; B32B 2405/00; B32B 2266/08; B32B 2307/202; B32B 2264/108; B32B 2457/208

(57) ABSTRACT

An electroconductive pressure-sensitive adhesive cushioning member includes an electroconductive resin foam layer, an electroconductive composite layer, and an electroconductive intermediate layer disposed between the electroconductive resin foam layer and the electroconductive composite layer. The electroconductive composite layer includes an electroconductive base layer and an electroconductive attachment layer disposed on a surface of the electroconductive base layer and having an attachment surface to be attached to an obstacle. Thus, the electroconductive cushioning member is excellent in conductivity, an electromagnetic waves shieling property, and a cushioning property.

### CROSS REFERENCE TO RELATED APPLICATION

This application claims priority from Japanese Patent Application No. 2014-224509 filed Nov. 4, 2014. The entire contents of the priority application are incorporated herein by reference.

### FIELD OF THE INVENTION

The present disclosure relates to an electroconductive pressure-sensitive adhesive cushioning member.

### BACKGROUND

Touch panels have been widely used as input devices of display devices. Various types of touch panels having different operation principles such as a capacitance type touch panel and a resistive touch panel have been known. A type of touch panel is selected according to a usage or a cost of the display device.

For example, a capacitance type touch panel that is superior in response speed and precision has been widely used as the input device of the display device.

The capacitance type touch panel that is charged with static electricity may cause erroneous input, and it is necessary to remove the static electricity effectively. Therefore, in a display device including such a capacitance type touch panel, it has been proposed to earth the touch panel with using an electroconductive material described in Patent Document 1.

Such an electroconductive material described in patent Document 1 is used to remove the static electricity from the touch panel and also functions as an electromagnetic wave shield. The electroconductive material that is made of electroconductive resin foam having flexibility is disposed between components of the display device and functions as a cushioning sealant.

Patent Document 2 describes another example of the electroconductive and flexible member (a gasket) including an electroconductive base sheet and a porous material sheet having flexibility and conductivity that is layered on the electroconductive base sheet.

Patent Document 1: Japanese Unexamined Patent Application Publication No. 2010-229398

Patent Document 2: Japanese Unexamined Patent Application Publication No. 2012-104714

### SUMMARY OF THE INVENTION

According to the present technology, an electroconductive pressure-sensitive adhesive cushioning member includes an electroconductive resin foam layer, an electroconductive composite layer including an electroconductive base layer and an electroconductive attachment layer disposed on a surface of the electroconductive base layer and having an attachment surface to be attached to an obstacle, and an electroconductive intermediate layer disposed between the electroconductive resin foam layer and the electroconductive composite layer.

### BRIEF DESCRIPTION OF THE DRAWINGS

FIG. 1 is a cross-sectional view typically illustrating a configuration of an electroconductive pressure-sensitive adhesive cushioning member according to an embodiment of the present technology.

FIG. 2 is a schematic cross-sectional view of an upper electrode where a PET tape is attached.

FIG. 3 is a plan view of an electroconductive composite layer viewed from a conductive base layer side.

FIG. 4 is a cross-sectional view of an electroconductive composite layer of another embodiment.

FIG. 5 is a cross-sectional view of an electroconductive composite layer of another different embodiment.

FIG. 6 is cross-sectional view typically illustrating a general configuration of a liquid crystal display device including an electroconductive pressure-sensitive adhesive cushioning member.

FIG. 7 is a plan view of the electroconductive pressure-sensitive adhesive cushioning member included in the liquid crystal display device.

FIG. 8 is a plan view of a test sample for measuring resistance (bonded area: 50 mm×50 mm).

FIG. 9 is a side view of a pendulum tester that measures impact absorbing efficiency.

### DETAILED DESCRIPTION

There has been a demand for another member having conductivity, an electromagnetic wave shielding property, and a cushioning property that are superior to those of the conventional electroconductive member.

An objective of the present technology is to provide an electroconductive cushioning member that is good in conductivity, an electromagnetic shielding property, and a cushioning property.

Aspects of the present technology will be described with reference to the drawings.

FIG. 1 is a cross-sectional view typically illustrating a configuration of an electroconductive pressure-sensitive adhesive cushioning member according to one embodiment. As illustrated in FIG. 1, the electroconductive pressure-sensitive adhesive cushioning member 1 mainly includes an electroconductive resin foam layer 2, an electroconductive composite layer 3, and an electroconductive intermediate layer 7 that is between the electroconductive resin foam layer 2 and the electroconductive composite layer 3. The electroconductive composite layer 3 includes an electroconductive base layer 4 and an electroconductive attachment layer 5 including an attachment surface 5a that is to be attached to an object. The electroconductive attachment layer 5 is disposed on a surface of the electroconductive base layer 4. In this embodiment, the electroconductive pressure-sensitive adhesive cushioning member 1 includes a release liner 8 that covers the attachment surface 5a of the electroconductive attachment layer 5 before it is used, that is, before it is attached to the object.

The electroconductive pressure-sensitive adhesive cushioning member 1 of this embodiment may further include another layer such as an intermediate layer, an under coat coating layer, and a laminate layer as long as the object of the present technology is not hindered. Hereinafter, components of the electroconductive pressure-sensitive adhesive cushioning member 1 will be described.

(Electroconductive Resin Foam Layer)

The electroconductive resin foam layer 2 of this embodiment is made of following electroconductive resin foam.

The electroconductive resin foam has a volume resistivity of 10¹⁰ Ω·cm or less and has a repulsive load of 5N/cm² or less at 50% compression from an initial thickness (a repulsive load at 50% compression, 50% compression load). The electroconductive resin foam is excellent in conductivity and flexibility.

The electroconductive resin foam has a volume resistivity of 10¹⁰ Ω·cm or less, and preferably 10⁸ Ω·cm or less, and more preferably 10⁵ Ω·cm or less. The volume resistivity of the resin foam may be measured according to the double ring electrode method prescribed in Japanese Industrial Standards (JIS) K6271.

The electroconductive resin foam has a repulsive load of 5 N/cm² or less at 50% compression, preferably 4 N/cm² or less, and more preferably 3 N/cm² or less for ensuring conformability to a minute clearance. The repulsive load at 50% compression of the electroconductive resin foam may be measured according to the method for measuring a compression hardness prescribed in JIS K 6767.

For example, the electroconductive resin foam, when having a repulsive load of 4 N/cm² or less at 50% compression, may show very good conformability to surface asperities and is thereby advantageously usable for grounding of an electronic component having large surface asperities (e.g., surface asperities with difference in level of from 0.05 mm to 0.20 mm).

The electroconductive resin has a compression resistivity of preferably 10⁸ Ω·cm or less (more preferably 10⁵ Ω·cm or less) for satisfactorily conforming bumps in a bumpy portion and exhibiting satisfactory electrical conductivity even when being compressed.

The compression resistivity refers to a volume resistivity as measured by sandwiching the following electroconductive resin foam between a bumped upper electrode and a lower electrode, which will be described below, so that the bumped surface of the upper electrode be in contact with the electroconductive resin foam, and compressing the electroconductive resin foam from above by 5% (at a compression ratio of 5%) in the thickness direction.

Electroconductive resin foam: sheet-like electroconductive resin foam 25 mm long, 25 mm wide, and 1 mm thick

Bumped upper electrode: Electrode with being obtained by applying two plies of a PET tape 25 mm long, 7.5 mm wide, and 0.1 mm thick to both ends of an electrode 25 mm long and 25 mm wide, and the resulting electrode having a depression 25 mm long, 10 mm wide, and 0.1 mm deep on a side to be in contact with the electroconductive resin foam

Lower electrode: Electrode with a smooth surface, 25 mm long and 25 mm wide

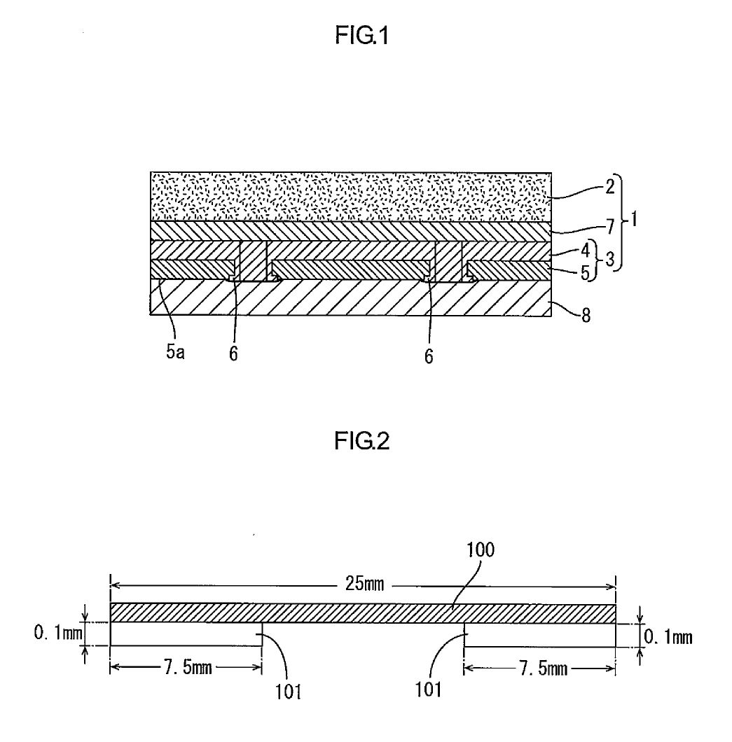

FIG. 2 illustrates a schematic cross-sectional view of an exemplary bumped upper electrode.

The electroconductive resin foam has a surface resistivity of 10¹⁰Ω per square or less (preferably 10⁸Ω per square or less, more preferably 10⁵Ω per square or less) in addition to having a volume resistivity of 10¹⁰ Ω·cm or less.

The electroconductive resin foam may have an apparent density of 0.15 g/cm³ or less, more preferably 0.10 g/cm³ or less, and furthermore preferably 0.07 g/cm³ or less, for further higher flexibility. In contrast, for satisfactory electrical conductivity, the electroconductive resin foam has an apparent density of preferably 0.01 g/cm³ or more, and more preferably 0.02 g/cm³ or more.

The electroconductive resin foam may have an expansion ratio of preferably 9 times or more (e.g., from 9 times to 50 times), and more preferably 15 times or more (e.g., from 15 times to 30 times), for satisfactory flexibility and satisfactory shock absorptivity. The electroconductive resin foam having the expansion ratio within the above range has sufficient flexibility and shock absorptivity and is less likely to have lowered strength.

The expansion ratio of the electroconductive resin foam may be determined by calculation according to the following expression:

Expansion ratio(times)=(Density before expansion)/(Density after expansion)

The density before foaming corresponds to the density of a molded article that is not foamed, or the density of a resin composition before foaming in the case when the resin composition is molten, and the molten resin is impregnated with an inert gas to form the electroconductive resin foam. The density after foaming corresponds to the apparent density of the electroconductive resin foam.

The electroconductive resin foam has an average cell diameter (an average foam diameter) of preferably 250 μm, more preferably 200 μm or less, furthermore preferably 100 μm or less, and still more preferably 80 μm or less. This allows the electroconductive resin foam to be capable of processed into a thin article, to thereby be conformable to minute clearance, and to show higher dustproofness. In contrast, the electroconductive resin foam has an average cell diameter of preferably 10 μm or more, more preferably 15 μm or more, and furthermore preferably 20 μm or more, for further satisfactory shock absorptivity (cushioning property).

The electroconductive resin foam layer made of the electroconductive resin foam has a thickness of preferably 2.0 mm or less, more preferably 1.0 mm or less, and furthermore preferably 0.5 mm or less. This may allow the electroconductive resin foam layer to be processed into a thin article easily and to conform further satisfactorily to a minute clearance. The electroconductive resin form layer has a thickness of generally 0.2 mm or more, and preferably 0.3 mm or more.

The electroconductive resin foam preferably has a cell structure of a closed cell structure or semiopen/semiclosed cell structure, for the formation of a conduction path (electroconductive network) and for satisfactory dustproofness. The semiopen/semiclosed cell structure is a cell structure in which a closed cell structure and an open cell structure are present in coexistence, whereas the ratio between the two structures is not limited. In particular, the electroconductive resin foam preferably has such a cell structure that a closed cell structure region occupies 50% or more, more preferably 80% or more, and particularly preferably 90% or more of the electroconductive resin foam.

The volume resistivity and the surface resistivity of the electroconductive resin foam may be controlled by selecting the type of the resin and/or regulating the type and amount of the electrically electroconductive substance.

The repulsive load at 50% compression, apparent density, expansion ratio, average cell diameter, and cell structure of the resin foam may be controlled by suitably choosing or setting foaming molding conditions including operation conditions in the gas impregnation step, such as temperature, pressure, time, and amount of gas to be mixed; operation conditions in the decompression step, such as decompression rate, temperature, and pressure; and temperature of heating after decompression. These conditions may be chosen or set according to the type of the resin, the type of the blowing agent, and the types of electrically conductive substance and other additives.

For example, the resin composition may be a resin composition including a thermoplastic resin and a carbonaceous filler, in which the carbonaceous filler has a BET specific surface area of 500 m²/g and is present in an amount of 3 to 20 parts by mass per 100 parts by mass of the thermoplastic resin. The use of this resin composition gives an electroconductive resin foam including a thermoplastic resin and a carbonaceous filler, in which the carbonaceous filler has a BET specific surface area of 500 m²/g and is present in an amount of from 3 to 20 parts by mass per 100 parts by mass of the thermoplastic resin, and the resin foam has a volume resistivity of 10¹⁰ Ω·cm or less and a repulsive load of 5 N/cm² or less at 50% compression.

The use of the resin composition further gives an electroconductive resin foam including a thermoplastic resin, and a carbonaceous filler present in an amount of from 3 to 20 parts by mass per 100 parts by mass of the thermoplastic resin in which the resin foam has a volume resistivity of 10¹⁰ Ω·cm or less, has a repulsive load of 5 N/cm² or less at 50% compression, and has one or more controlled properties such as surface resistivity, expansion ratio, apparent density, compression resistivity, and average cell diameter.

For example, the resin composition may give an electroconductive resin foam including a thermoplastic resin and a carbonaceous filler, the carbonaceous filler having a BET specific surface area of 500 m²/g and being present in an amount of from 3 to 20 parts by mass per 100 parts by mass of the thermoplastic resin, in which the resin foam has a volume resistivity of 10¹⁰ Ω·cm or less, a repulsive load of 5 N/cm² or less at 50% compression, an average cell diameter of from 10 μm to 250 μm, and an apparent density of from 0.01 g/cm³ to 0.15 g/cm³.

The electroconductive resin foam is satisfactory flexible and satisfactory electrically conductive, has been highly expanded, and is lightweight. In addition, the electroconductive resin foam is conformable to a minute clearance. In particular, the electroconductive resin foam, even when being compressed, is satisfactorily flexible and electrically conductive. Even when compressed by 5% in the thickness direction, the electroconductive resin foam is satisfactorily conformable to bumps and exhibits a low volume resistivity. The electroconductive resin foam, when having a fine cell structure, can be satisfactorily processed into a desired shape. In addition, the electroconductive resin foam, when being controlled in average cell diameter, is improved particularly in dustproofness.

The resin composition for forming an electroconductive resin foam includes at least resin and electrically conductive substance.

The resin for use as a material for the electroconductive resin foam is not limited, as long as being a polymer having thermoplasticity (being a thermoplastic polymer) and capable of being impregnated with a high-pressure gas. Examples of such thermoplastic polymers include olefinic polymers such as low-density polyethylenes, medium-density polyethylenes, high-density polyethylenes, linear low-density polyethylenes, polypropylenes, copolymers between ethylene and propylene, copolymers between ethylene or propylene and another α-olefin, and copolymers between ethylene and another ethylenically unsaturated monomer (e.g., vinyl acetate, acrylic acid, an acrylic acid ester, methacrylic acid, a methacrylic acid ester, or vinyl alcohol); styrenic polymers such as polystyrenes and acrylonitrile-butadiene-styrene copolymers (ABS resins); polyamindes such as 6-nylon, 66-nylon, and 12-nylon; polyamideimides; polyurethanes; polyimides; polyetherimides; acrylic resins such as poly(methyl methacrylate)s; poly(vinyl chloride)s; poly(vinyl fluoride)s; alkenyl aromatic resins; polyesters such as poly(ethylene terephthalate)s and poly(butylene terephthalate)s; polycarbonates such as bisphenol-A polycarbonates; polyacetals; and poly(phenylene sulfide)s.

Examples of the thermoplastic polymer further include thermoplastic elastomers which have properties as rubber at normal temperature (room temperature) and have plasticity at high temperatures. Exemplary thermoplastic elastomers include olefinic elastomers such as ethylene-propylene copolymers, ethylene-propylene-diene copolymers, ethylene-vinyl acetate copolymers, polybutenes, polyisobutylenes, and chlorinated polyethylenes; styrenic elastomers such as styrene-butadiene-styrene copolymers, styrene-isoprene-styrene copolymers, and styrene-isoprene-butadiene-styrene copolymers, as well as polymers as hydrogenated products of them; thermoplastic polyester elastomers; thermoplastic polyurethane elastomers; and thermoplastic acrylic elastomers. Each of such thermoplastic elastomers has, for example, a glass transition temperature of equal to or lower than room temperature (e.g., 20° C. or lower) and thereby gives a resin foam having significantly excellent flexibility and dimensional conformability.

Each of different thermoplastic polymers may be used alone or in combination. The material for the electroconductive resin foam may be a thermoplastic elastomer, another thermoplastic polymer than thermoplastic elastomer; or a mixture of a thermoplastic elastomer and another thermoplastic polymer than thermoplastic elastomer.

Examples of the mixture of a thermoplastic elastomer and another thermoplastic polymer than thermoplastic elastomer include a mixture of an olefinic elastomer (e.g., an ethylene-propylene copolymer) and an olefinic polymer (e.g., a polypropylene). The ratio of a thermoplastic elastomer to another thermoplastic polymer than thermoplastic elastomer, when used in combination as a mixture, is typical from about 1:99 to about 99:1, preferably from about 10:90 to about 90:10, and more preferably from about 20:80 to about 80:20.

The electrically conductive substance is contained as an essential additive in the resin composition. The electroconductive resin foam according to this embodiment is formed from such a resin composition containing the electrically conductive substance. This contributes typically to the formation of a conduction path and the control of the electrical conductivity. Each of different electrically conductive substances may be used alone or in combination.

The electrically conductive substance is not limited, as long as forming a conduction path in the electroconductive resin foam and allowing the resin foam to have a volume resistivity of 10¹⁰ Ω·cm or less. In this embodiment, the resin composition contains a carbonaceous filler as an essential electrically conductive substance, because the use of such a carbonaceous filler enables easy formation of a conduction path and easy control of electrical conductivity and allows the electroconductive resin foam to have stable properties.

The resin composition may contain, as an optional electrically conductive substance, one or more fillers other than carbonaceous fillers, such as metallic fillers and other fillers.

Exemplary metallic fillers include fillers of pure metals such as copper, silver, gold, iron, platinum, nickel, and aluminum; fillers of alloys such as stainless steel and brass; and fillers of metal oxides such as aluminum oxide, titanium oxide, zinc oxide, silver oxide, magnesium oxide, calcium oxide, barium oxide, strontium oxide, silicon oxide, and zirconium oxide. Exemplary other fillers include carbonates such as calcium carbonate and magnesium carbonate; sulfates such as barium sulfate; hydroxides such as aluminum hydroxide and magnesium hydroxide; silicic acid and salts thereof; clay; talc: mica; bentonite; silica; aluminum silicate; and basalt fibers.

The resin composition may contain a carbonaceous filler as an essential electrically conductive substance and another filler than carbonaceous filler as an optional electrically conductive substance. In this case, it is important that the carbonaceous filler occupies 80 mass % or more, preferably 90 mass % or more, of the total mass of the electrically conductive substances.

Exemplary carbonaceous fillers include carbon fibers, carbon blacks, graphite, carbon nanotubes, fullerenes, and activated carbons.

Among the carbonaceous fillers, so-called electrically conductive carbon blacks are preferred, because they enable easy formation of a conduction path and easy control of electrical conductivity and allow the resin foam to exhibit properties stably. Exemplary electrically conductive carbon blacks include acetylene black, Ketjenblack, furnace black, channel black, thermal black, and carbon nanotubes. Among such electrically conductive carbon blacks, Ketjenblack is preferred.

The electrically conductive substance has such a structure as to have a BET specific surface area of preferably 500 m²/g or more, and more preferably 1000 m²/g or more. The electrically conductive substance, when having the structure, can provide a desired electrical conductivity even present in a small amount, and the electrically conductive substance, when used in such a small amount, does not adversely affect the performance of the resin composition (e.g., does not adversely affect the flowability of the resin composition). The electrically conductive substances, when having such a large surface area, are easily in contact with each other and thereby easily form a conduction path.

The electrically conductive substance is not limited in its shape and may have, for example, a powdery amorphous, spherical, rod-like, staple, plate-like, or cylindrical (tubular) shape. The electrically conductive substance, when typically having a cylindrical (tubular) shape, may often have a large specific surface area.

The electrically conductive substance may have a hollow structure. The electrically conductive substance, when having such a hollow structure, may often have a large BET specific surface area.

In this embodiment, an electrically conductive substance having a hollow structure is more preferred than one having a solid structure. This is because not the mass, but the surface area of the electrically conductive substance significantly affects the formation of a conduction path in the electroconductive resin foam, and the electrically conductive substance having a hollow structure can have a larger surface area per mass than that of one having a solid structure. In addition, the electrically conductive substance having a hollow structure can be used in a smaller mass per volume, and this protects the resin composition from deterioration in performance.

The electrically conductive substance is not limited in its surface shape and may have a smooth surface or a rough surface with asperities. The electrically conductive substance, when having a rough surface or porous surface, may often have a large specific surface area.

Though not critical, the amount of the electrically conductive substance is preferably from 3 to 20 parts by mass, and more preferably from 5 to 10 parts by mass per 100 parts by mass of the resin. The electrically conductive substance that is present in an amount of the above range imparts sufficient electrical conductivity to the resin foam and does not adversely affect the flowability of the resin composition and provides a highly expanded foam.

In the present embodiment, the resin composition may further contain one or more additives according to necessity, in addition to the electronically conductive substance. The additives are not limited in their types and may be a variety of additives generally used in expansion molding. Examples of such additives include foaming nucleators, crystal nucleators, plasticizers, lubricants, colorants (e.g., pigments and dyestuffs), ultraviolet absorbers, antioxidants, age inhibitors, fillers other than the electrically conductive substances, reinforcers, flame retardants, antistatic agents, surfactants, vulcanizers, and surface preparation agents. The amounts of additives may be chosen within ranges not impeding, for example, the formation of bubbles (cells) and may be such amounts as commonly used in expansion/molding of resins. Each of different additives may be used alone or in combination.

The lubricants help the resin to have higher flowability and to less suffer from thermal degradation. Such lubricants for use herein are not limited, as long as being capable of helping the resin to have higher flowability, and examples thereof include hydrocarbon lubricants such as liquid paraffins, paraffin waxes, microcrystalline waxes, and polyethylene waxes; fatty acid lubricants such as stearic acid, behenic acid, and 12-hydroxystearic acid; and ester lubricants such as butyl stearate, stearic acid monoglyceride, pentaerythritol tetrastearate, hydrogenated caster oil, and stearyl stearate. Each of different lubricants may be used alone or in combination.

The amount of lubricants is typically from 0.5 to 10 parts by mass, preferably from 0.8 to 8 parts by mass, and more preferably from 1 to 6 parts by mass, per 100 parts by mass of the resin. Lubricants used in an amount of the above range are less likely to cause the resin composition to have excessively high flowability and have insufficient expansion ratio and likely to help the resin to have satisfactory flowability and less likely to cause the resin to stretch insufficiently upon expansion and case the resin foam to have an insufficient expansion ratio.

The shrinkage inhibitors help to form molecular films on surfaces of cell membranes (cell walls) of the electroconductive resin foam to effectively block the permeation of the blowing agent gas. Such shrinkage inhibitors are not limited, as long as having the function of blocking the permeation of the blowing agent gas. The shrinkage inhibitors can be any of metal salts of fatty acids and fatty amides. Exemplary metal salts of fatty acids include aluminum, calcium, magnesium, lithium, barium, zinc, and lead salts of fatty acids such as stearic acid, behenic acid, and 12-hydroxystearic acid. Exemplary fatty amides include fatty amides whose fatty acid group having carbon number of about 12 to about 38 (preferably about 12 to about 22), such as stearamide, oleamide, erucamide, methylene bis(stearamide), ethylene bis(stearamide), and lauric bisamide. Such fatty amides may be either monoamides and bisamides, but bisamides are preferred for giving a fine cell structure. Each of different shrinkage inhibitors may be used alone or in combination.

The amount of shrinkage inhibitors is typically from 0.5 to 10 parts by mass, preferably from 0.7 to 8 parts by mass, and more preferably from 1 to 6 parts by mass, per 100 parts by mass of the resin. Shrinkage inhibitors used in an amount within the above range are less likely to lower the gas efficiency during the cell growth process and less likely to cause an insufficient expansion ratio and likely to sufficiently help to form films over cell walls to prevent occurrence of gas escape during foaming and less likely to cause an insufficient expansion ratio.

Different types of additives, e.g., the lubricant and the shrinkage inhibitor, may be used in combination. For example, one or more lubricants such as stearic acid monoglyceride may be used in combination with one or more shrinkage inhibitors such as erucamide and lauric bisamide.

The resin composition may be obtained according to a known or customary technique. Typically, the resin composition may be obtained by adding an electroconductive substance and, where necessary, additives to a material resin for the electroconductive resin foam, and kneading them. The kneading may be performed with heating.

The resin composition is used for the formation of an electroconductive resin foam having a volume resistivity of 10¹⁰ Ω·cm or less and a repulsive load of 5 N/cm² or less at 50% compression. In an exemplary embodiment of the resin composition, the resin composition contains a thermoplastic resin and a carbonaceous filler, in which the carbonaceous filler has a BET specific surface area of 500 m²/g and is present in an amount of from 3 to 20 parts by mass per 100 parts by mass of the thermoplastic resin.

Methods of forming the electroconductive resin foam are not limited and include customary techniques such as physical techniques and chemical techniques. An exemplary customary physical technique is a technique in which a low-boiling liquid (blowing agent), such as chlorofluorocarbon or a hydrocarbon, is dispersed in a resin, and the resin bearing the blowing agent is heated to volatilize the blowing agent to thereby form bubbles (cells).

To give a foam having a small cell diameter and a high cell density easily, the foaming is preferably performed according to a technique using a high-pressure inert gas as the blowing agent.

Specific examples of ways to produce the electroconductive resin foam from a resin composition by using a high-pressure inert gas as the blowing agent include a process including the steps of impregnating resin with an inert gas under high pressure (gas impregnation step); decompressing the impregnated resin after the gas impregnation step to expand the resin (decompression step); and, where necessary, heating the expanded resin for cell growth (heating step). In this process, it is accepted that the resin composition is previously molded to give an unexpanded molded article, and the unexpanded molded article is impregnated with an inert gas; or that the resin composition is melted, and the molten resin is impregnated with an inert gas under pressure (under a load), and the impregnated resin is molded upon decompression. Each of these steps may be performed according to a batch system or continuous system.

The inert gas for use herein is not especially limited, as long as being inert to the resin and being impregnatable into the resin. Exemplary inert gases include carbon dioxide, nitrogen gas, and air. These gases may be used in combination as a mixture. Of these, carbon dioxide is preferred, because it can be impregnated in a large amount and at a high rate into the resin to be used as a material for constituting the foam. Carbon dioxide is also preferred from the viewpoint of giving a resin foam which contains less impurities and is clean.

The inert gas upon impregnation into the resin is preferably in a supercritical state. The inert gas, when being in a supercritical state, shows increased solubility in the resin and can thereby be incorporated in the resin in a higher concentration. In addition, because of its high concentration, the supercritical inert gas generates a larger number of cell nuclei upon an abrupt pressure drop after impregnation. These cell nuclei grow to give cells which are present in a higher density than in a foam having the same porosity. Consequently, use of a supercritical inert gas can give fine micro cells. Carbon dioxide has a critical temperature and a critical pressure of 31° C. and 7.4 MPa, respectively.

According to the batch system, an electroconductive resin foam may be prepare, for example, in the following manner. Initially, an unexpanded molded article (e.g., a resin sheet for the formation of foam) is formed by extruding the resin composition through an extruder such as a single-screw extruder or twin-screw extruder. Alternatively, such an unexpanded molded article (e.g., a resin sheet for the formation of foam) is formed by uniformly kneading the resin composition in a kneading machine equipped with one or more blades typically of roller, cam, kneader, or Banbury type; and press-forming the kneaded resin composition with a hot-plate press. The resulting unexpanded molded article is placed in a pressure-tight vessel, a high-pressure inert gas is injected into the vessel, and the unexpanded molded article is impregnated with the inert gas. In this case, the unexpanded molded article is not especially limited in shape and can be in any form such as a roll form or sheet form. The injection of the high-pressure inert gas may be performed continuously or discontinuously. At the time of when the unexpanded molded article is sufficiently impregnated with the high-pressure inert gas, the unexpanded molded article is released from the pressure (the pressure is usually lowered to atmospheric pressure) to thereby generate cell nuclei in the resin. The cell nuclei may be allowed to grow at room temperature without heating, or may be allowed to grow by heating according to necessity. The heating may be performed according to a known or common procedure such as heating with a water bath, oil bath, hot roll, hot-air oven, far-infrared rays, near-infrared rays, or microwaves. After the cells have grown in the above manner, the article is rapidly cooled typically with cold water to fix its shape.

According to the continuous system, an electroconductive resin foam may be formed typically in the following manner. Specifically, the resin composition is kneaded in an extruder such as a single-screw extruder or twin-screw extruder, and during the kneading, a high pressure inert gas is injected so as to impregnate the resin with the gas sufficiently. The resulting article is then extruded and thereby released from the pressure (the pressure is usually lowered to atmospheric pressure) to perform expansion and molding simultaneously to thereby allows cells to grow. In some cases, heating is performed to assist the growth of cells. After cells have grown, the extruded article is rapidly cooled typically with cold water to fix its shape.

The pressure in the gas impregnation step is typically 6 MPa or more (e.g., from about 6 to about 100 MPa), and preferably 8 MPa or more (e.g., from about 8 to about 100 MPa). If the pressure of the inert gas is lower than 6 MPa, considerable cell grown may occur during foaming, and this may cause the cells to have too large diameters to give a small average cell diameter within the above-specified range and may cause insufficient dustproofing effects. The reasons for this are as follows. When impregnation is performed under a low pressure, the amount of the impregnated gas is relatively small and the cell nuclei grow at a lower rate as compared to impregnation under a higher pressure. As a result, cell nuclei are formed in a smaller number. Because of this, the gas amount per cell increases rather than decreases, resulting in excessively large cell diameters. Furthermore, under pressures lower than 6 MPa, only a slight change in impregnation pressure result in considerable changes in cell diameter and cell density, and this may often impede control of cell diameter and cell density.

The temperature in the gas impregnation step may vary depending typically on the types of the inert gas and resin to be used and can be chosen within a wide range. When impregnation operability and other conditions are taken into account, the impregnation temperature is typically from about 10° C. to about 350° C. For example, when an unfoamed molded article in a sheet form is impregnated with an inert gas according to a batch system, the impregnation temperature is from about 10° C. to about 250° C., preferably from about 10° C. to about 200° C., and more preferably from about 40° C. to about 200° C. When an molten resin composition is impregnated with a gas and is extruded to perform foaming (expansion) and molding simultaneously according to continuous system, the impregnation temperature is generally from about 60° C. to about 350° C. When carbon dioxide is used as the inert gas, the impregnation temperature is preferably 32° C. or higher, and more preferably 40° C. or higher in order to keep carbon oxide in a supercritical state.

Though not critical, the amount of the inert gas (gas as a blowing agent) to be impregnated is preferably from 1 to 15 mass %, more preferably 2 to 12 mass %, and furthermore preferably 3 to 10 mass %, relative to the total amount of resin(s) in the thermoplastic resin composition, for satisfactory expansion and for a cell structure having a small average cell diameter typically within the above range.

The decompression in the decompression step is preferably performed at a decompression rate of from about 5 to about 200 MPa/second, for obtaining more uniform fine cells. The heating in the heating step may be performed at a temperature of typically from about 40° C. to about 250° C., and preferably from about 60° C. to about 250° C.

Exemplary process for producing a resin foam having a volume resistivity of 10¹⁰ Ω·cm or less and a repulsive load of 5 N/cm² or less at 50% compression include a process (first embodiment) for producing a resin foam through the steps of impregnating a resin composition with a high-pressure inert gas, and decompressing the impregnated resin composition; and a process (second embodiment) for producing a resin foam through the steps of preparing an unexpanded molded article from the resin composition impregnating the unexpanded molded article with a high-pressure inert gas, and decompression the impregnated unexpanded molded article.

In a more specific embodiment, the resin foam is produced by a process including the steps of impregnating a resin composition with a high-pressure inert gas; and decompressing the impregnated resin composition, in which the resin composition contains a thermoplastic resin and a carbonaceous filler, and the carbonaceous filler has a BET specific surface area of 500 m²/g and is present in an amount of from 3 to 20 parts by mass per 100 parts by mass of the thermoplastic resin. In another specific embodiment, the resin foam is produced by a process including the steps of preparing an unexpanded molded article from a resin composition; impregnating the unexpanded molded article with a high-pressure inert gas; and decompressing the impregnated unexpanded molded article, in which the resin composition contains a thermoplastic resin and a carbonaceous filler, and the carbonaceous filler has a BET specific surface area of 500 m²/g and is present in an amount of from 3 to 20 parts by mass per 100 parts by mass of the thermoplastic resin.

(Electroconductive Composite Layer)

The electroconductive composite layer 3 includes the electroconductive base layer 4 and the electroconductive attachment layer 5 that is disposed on one surface of the electroconductive base layer 4 and includes the attachment surface 5a attached to the object.

The electroconductive composite layer 3 illustrated in FIG. 1 includes a metal foil as the electroconductive base layer 4 and a pressure-sensitive adhesive layer as the electroconductive attachment layer 5 that is disposed on one surface of the metal foil. The electroconductive base layer 4 includes terminal portions 6 that are parts of the metal foil and extend through the electroconductive pressure-sensitive adhesive layer in a thickness direction thereof.

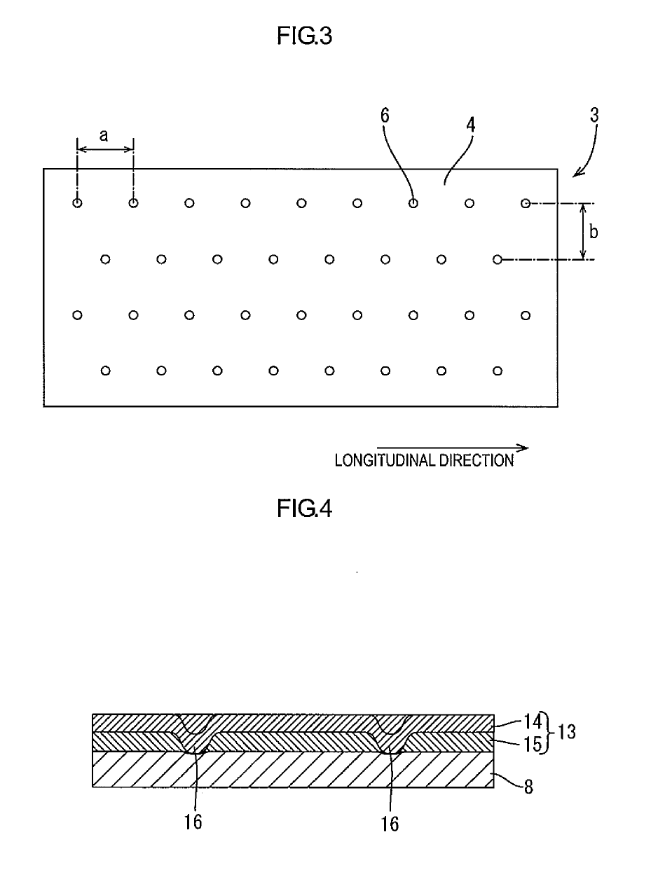

FIG. 3 is a plan view of the electroconductive composite layer 3 viewed from the electroconductive base layer 4 side. As illustrated in FIG. 3, the terminal portions 6 are formed in a spaced dot pattern on the electroconductive base layer 4 of the electroconductive composite layer 3. In the spaced dot pattern, the terminal portions 6 are disposed at intervals a in a long-side direction (in one direction) to form a row and rows of the terminal portions 6 are disposed at intervals b in a short-side direction. The terminal portions 6 of one row are displaced by a half of the interval a from the terminal portions 6 of another row that is adjacent to the one row. The interval a is substantially equal to the interval b.

(Metal Foil)

The metal foil may be a metal foil of copper, aluminum, nickel, silver, iron, lead, or an alloy thereof. Among the above, an aluminum foil and a copper foil are preferred because a cost is and the metal foil in view of a cost and an effective processing property. The metal foil may be processed with surface-finishing such as tinning. A thickness of the metal foil is not limited and may be selected from a range from about 5 μm to 500 μm, preferably 8 μm to 200 μm, and more preferably 10 μm to 150 μm, in view of the balance of strength and flexibility.

An adhesive for constituting the pressure-sensitive adhesive layer is not limited and may be suitably chosen from among known adhesives such as acrylic adhesives, rubber adhesives, vinyl alkyl ether adhesives, silicone adhesives, polyester adhesives, polyamide adhesives, urethane adhesives, fluorine adhesives, and epoxy adhesive. Each of different adhesives may be used alone or in combination with two or more. The adhesives may be adhesives of any type, such as active energy ray curing adhesives, solvent-type (solution-type) adhesives, emulsion adhesives, and hot-melt (thermally melt) adhesives.

Among the above adhesives, acrylic adhesives are preferred for use of constituting the adhesive layer. Namely, the pressure-sensitive adhesive layer is preferably an acrylic pressure-sensitive adhesive layer. The acrylic pressure-sensitive adhesive layer is preferably a pressure-sensitive adhesive layer (an acrylic pressure-sensitive adhesive layer) made of an adhesive composition containing acrylic polymer as an essential component. The adhesive composition may contain other components (additives) in addition to acrylic polymer if necessary. Though not critical, the content amount of acrylic polymer in the pressure-sensitive adhesive layer (the acrylic pressure-sensitive adhesive layer) (100 mass %) is preferably 65 mass % or more (for example, 65 to 100 mass %), and more preferably 70 to 99.999 mass %.

The acrylic polymer is preferably an acrylic polymer which is formed from a (meth)acrylic alkyl ester whose alkyl group being a linear or branched chain alkyl group as an essential monomer component. The term “(meth)acrylic” refers to “acrylic” and/or “methacrylic,” and the same is true for other descriptions.

The monomer component(s) constituting the acrylic polymer may further contain any of polar group-containing monomers, multifunctional monomer, and other copolymerizable monomers as copolymerizable monomers. These copolymerizable monomer components, when used, bonding strength to the adherend and cohesive force of the pressure-sensitive adhesive layer may be increased. Each of different copolymierizable monomer components may be used alone or in combination with two or more.

Examples of (meth)acrylic alkyl ester whose alkyl group being a linear or branched-chain alkyl group (hereinafter, simply referred to as “alkyl (meth)acrylate”) include alkyl (meth)acrylates whose alkyl group having a carbon number of 1 to 20, such as methyl(meth)acrylate, ethyl(meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl(meth)acrylate, isopentyl(meth)acrylate, hexyl(meth)acrylate, heptyl(meth)acrylate, octyl(meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. Among the above, alkyl (meth)acrylates whose alkyl group having a carbon number of 2 to 10 are preferred, and n-butyl (meth)acrylate is more preferred. Each of the alkyl (meth)acrylates may be used alone or in combination with two or more.

The content of the alkyl (meth)acrylate in the total amount of monomer component(s) (100 mass %) constituting the acrylic polymer is preferably 50 to 100 mass %, and more preferably 60 to 99.9 mass %.

Examples of the polar group-containing monomers include carboxyl-containing monomers such as (meth)acrylic acid, itaconic acid, maleic acid, fumaric acid, crotonic acid, isocrotonic acid or anhydride thereof (such as maleic anhydride); hydroxyl-containing monomers including hydroxylalkyl (meth)acrylates such as 2-hydroxyethyl (meth)acrylate, 3-hydroxypropyl (meth)acrylate, 4-hydroxybutyl (meth)acrylate, and 6-hydroxyhexyl (meth)acrylate, as well as vinyl alcohol, allyl alcohol; amide group-containing monomers such as (meth)acrylamide, N,N-dimethyl(meth)acrylamide, N-methylol(meth)acrylamide, N-methoxymethyl(meth)acrylamide, N-butoxymethyl(meth)acrylamide, and N-hydroxyethylacrylamide; amino-containing monomers such as aminoethyl(meth)acrylate, dimethylaminoethyl (meth)acrylate, and t-butylaminoethyl(meth)acrylate; glycidyl-containing monomers such as glycidyl(meth)acrylate and methylglycidyl(meth)acrylate; cyano-containing monomers such as acrylonitorile and methacrylonitrile; heterocyclic vinyl monomers such as N-vinyl-2-pyrolidone, (meth)acryloylmorpholine as well as N-vinylpyridine, N-vinylpiperidone, N-vinylpylimidine, N-vinylpiperazine, N-vinylpyrrole, N-vinylimidazole, and N-vinyloxazole; alkoxyalkyl (meth)acrylate monomers such as methoxyethyl(meth)acrylate and ethoxyethyl (meth)acrylate; sulfon-containing monomers such as sodium vinylsulfonate; phosphate-containing monomers such as 2-hydroxyethylacryloyl phosphate; imide-containing monomers such as cyclohexylmaleimide and isopropylmaleimide; and isocyanate-containing monomers such as 2-methacryloyloxyethyl isocyanate. Among the above, carboxyl-containing monomers are preferred as the polar group-containing monomer, and the acrylic acid is more preferred. Each of different polar group-containing monomers may be used alone or in combination with two or more.

The content of the polar group-containing monomer is preferable from 1 to 30 mass % in the total amount of the monomer component(s) (100 mass %) constituting the acrylic polymer, and more preferable from 3 to 20 mass %. If the content amount of the polar group-containing monomer is greater than 30 mass %, the cohesive force of the pressure-sensitive adhesive layer is excessively increased and the adhesive force may be lowered. If the content amount of the polar group-containing monomer is less than 1 mass %, the cohesive force of the pressure-sensitive adhesive layer is lowered and durability may be deteriorated.

Examples of the multifunctional monomers include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl(meth)acrylate, vinyl(meth)acrylate, divinylbenzene, epoxy acrylates, polyester acrylates, and urethane acrylates.

The content of the multifunctional monomers is preferably 0.5 mass % or less (for example, from 0 to 0.5 mass %) in the total amount of the monomer component(s) (100 mass %) constituting the acrylic polymer, and more preferably from 0 to 0.3 mass %. If the content amount of the multifunctional monomer is greater than 0.5 mass %, the cohesive force of the pressure-sensitive adhesive layer is excessively increased and the adhesive force may be lowered. If a crosslinking agent is contained, such a multifunctional monomer may not have to be used. However, when a crosslinking agent is not contained, the content of the multifunctional monomer is preferably from 0.001 to 0.5 mass %, and more preferably from 0.002 to 0.1 mass %.

Examples of copolymerizable monomers other than the polar group-containing monomers and the multifunctional monomers include (meth)acrylic esters each having an alicyclic hydrocarbon group such as cyclopentyl (meth)acrylate, cyclohexyl (meth)acrylate, and isobornyl (meth)acrylate; (meth)acrylic aryl ester such as phenyl (meth)acrylate; vinyl esters such as vinyl acetate and vinyl propanate; aromatic vinyl compounds such as styrene, and vinyltoluene; olefins or dienes such as ethylene, butadiene, isoprene, and isobutylene; vinyl ethers such as vinyl alkyl ethers; and vinyl chloride.

The acrylic polymers may be prepared through polymerization of the above monomer components according to a known polymerization technique. Exemplary polymerization techniques include solution polymerization, emulsion polymerization, bulk polymerization, and a polymerization upon irradiation with an active energy ray (polymerization with an active energy ray). Among the above, solution polymerization and polymerization with an active energy ray are preferred for satisfactory transparency and water resistance, of which solution polymerization is more preferred.

The solution polymerization may employ any of regular solvents of various kinds. Exemplary solvents include organic solvents including esters such as ethyl acetate, and n-butyl acetate; aromatic hydrocarbons such as toluene, and benzene; aliphatic hydrocarbons such as n-hexane, and n-heptane; alicyclic hydrocarbons such as cyclohexane, and methylcyclohexane; and ketnones such as methyl ethyl ketone, and methyl isobutyl ketone. Each of different solvents may be used alone or in combination with two or more.

A polymerization initiator used in polymerization of the acrylic polymer is not limited and may be appropriately selected from known polymerization initiators. Specifically, the polymerization initiators may be preferably oil-soluble polymerization initiators including azo polymerization initiators such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane), and dimethyl-2,2′-azobis(2-methyl propionate); and peroxide polymerization initiators such as benzoyl peroxide, t-butyl hydroperoxide, di-t-butyl peroxide, t-butyl peroxybenzoate, dicumyl peroxide, 1,1-bis(t-butyl peroxy)-3,3,5-trimethylcyclohexane, and 1,1-bis(t-butyl peroxy)cyclododecane. Each of different polymerization initiators may be used alone or in combination with two or more. The amount of the polymerization initiator is not limited and may be in a range so as to be used as the polymerization initiator.

The acrylic polymer has a weight-average molecular weight of preferably from 300,000 to 1,200,000, more preferably from 350,000 to 1,000,000, and further more preferably from 400,000 to 900,000. If the weight-average molecular weight of the acrylic polymer is less than 300,000, good adhesive properties may not be provided. If the weight-average molecular weight of the acrylic polymer is greater than 1,200,000, a problem may be caused in coating properties. The weight-average molecular weight may be typically controlled by the type and amount of the polymerization initiators, the temperature, time, monomer concentrations, and a monomer dripping rates upon polymerization.

The adhesive composition for use in the pressure-sensitive adhesive layer included in the electroconductive attachment layer may preferably contain a crosslinking agent. The crosslinking agent crosslinks the base polymer included in the pressure-sensitive adhesive layer (such as acrylic polymer) and the cohesive force of the pressure-sensitive adhesive layer is further increased. The crosslinking agent is not limited and may be suitably chosen from among known crosslinking agents. Preferred examples of crosslinking agents include multifunctional melamine compounds (melamine crosslinking agents), multifunctional epoxy compounds (epoxy crosslinking agents), and multifunctional isocyanate compounds (isocyanate crosslinking agents). Among the above, isocyanate crosslinking agents and epoxy crosslinking agents are preferred, of which isocyanate crosslinking agents are more preferred. Each of different crosslinking agents may be used alone or in combination with two or more.

Examples of the isocyanate crosslinking agents include a lower aliphatic polyisocyanate such as 1,2-etylene diisocyanate, 1,4-buthylene diisocyanate, and 1,6-hexamethylene diisocyanate; alicyclic polyisocyanate such as cyclopenthylen diisocyanate, cyclohexylene diisocyanate, isophorone diisocyanate, hydrogenated tolylene diisocyanate, and hydrogenated xylene diisocyanate; aromatic polyisocyanate such as 2,4-tolylene diisocyanate, 2,6-tolylene diisocyanate, 4,4′-diphenylmethane diisocyanate, and xylene diisocyanate, as well as an adduct of tolylene diisocyanate with trimethylolpropane [trade name “CORONATE L” supplied by Nippon Polyurethane Industry Co., Ltd.] and an adduct of hexamethylene diisocyanate with trimethylolpropane [trade name “CORONATE HL” supplied by Nippon Polyurethane Industry Co., Ltd.].

Examples of the epoxy crosslinking agents include N,N,N′,N′-tetraglycidyl-m-xylenediamine, diglycidyl aniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, solbitan polyglycidyl ether, trimethylolpropane polyglycidyl ether, diglycidyl adipate, diglycidyl o-phthalate, triglycidyl-tris(2-hydroxyethyl)isocyanurate, resorcinol glycidyl ether, bisphenol-S-glycidyl ether, and epoxy resins each having two or more epoxy groups per one molecule. Exemplary commercial products usable as epoxy crosslinking agents include a product under trade name “TEDRAD C” supplied by Mitsubishi gas Chemical Company, Inc.

The content of the crosslinking agent in the adhesive composition is not critical. In the acrylic pressure-sensitive adhesive layer, the content of the crosslinking agent in a total amount of the monomer component(s) constituting the acrylic polymer (100 parts by mass) is preferably from 0 to 5 parts by mass, and more preferably from 0 to 3 parts by mass.

The adhesive composition preferably contains tackifier resin (a tackifier) in view of increasing adhesive properties. Examples of the tackifier resin include terpene tackifier resin, phenol tackifier resin, rosin tackifier resin, and petroleum tackifier resin. Among the above, the rosin tackifier resin is preferred. Each of different tackifier resin may be used alone or in combination with two or more.

Examples of the terpene tackifier resin include terpene resin and modified terpene resin. The terpene resin includes α-pinene polymer, β-pinene polymer, dipentene polymer. The modified terpene resin is obtained by modifying (phenol-modified, aromatic-modified, hydrogenation-modified, hydrocarbon-modified) the terpene resins. The modified terpene resin includes terpenephenol resin, styrene-modified terpene resin, aromatic-modified terpene resin, and hydrogenation-modified terpene resin.

Examples of the phenol tackifier resin include condensate (such as alkylphenol resin, and xylene formaldehyde resin) of various phenol (such as phenol, m-cresol, 3,5-xylenol, p-alkylphenol, resorcine) and formaldehyde, resol, novolak, and rosin-modified phenol resin. The resol is obtained by an addition reaction of the phenol and the formaldehyde with acid catalyst. The novolak is obtained by condensation reaction of the phenol and the formaldehyde with acid catalyst. The rosin-modified phenol resin is obtained by adding the phenol to the rosin (such as unmodified rosin, modified rosin, and various rosin derivatives) with acid catalyst and thermally polymerizing the added article.

Examples of the rosin tackifier resin include unmodified rosin (row rosin) such as gum rosin, wood rosin, and tall oil rosin, modified rosin obtained by modifying the unmodified rosin with hydrogenation, disproportionation, or polymerization (hydrogenated rosin, disproportionated rosin, polymerized rosin, and other chemically modified rosin), and various rosin derivatives. Examples of the rosin derivatives are as follows. Rosin ester such as an ester compound of rosin obtained by esterification of the unmodified rosin with alcohol and an ester compound of modified rosin obtained by esterification of the modified resin (such as hydrogenated rosin, disproportionated rosin, polymerized rosin) with alcohol. An unsaturated fatty-acid modified rosin obtained by modifying the unmodified rosin or the modified rosin (such as hydrogenated rosin, disproportionated rosin, polymerized rosin) with unsaturated fatty acid. An unsaturated fatty-acid modified rosin ester is obtained by modifying rosin ester with unsaturated fatty acid. Rosin alcohol obtained by putting a carboxyl group in the unmodified rosin, the modified rosin (such as hydrogenated rosin, disproportionated rosin, polymerized rosin), the unsaturated fatty-acid modified rosin, and the unsaturated fatty-acid modified rosin ester with a reduction treatment. Metal salt of the rosin (specifically, rosin ester) such as the unmodified rosin, the modified rosin, and the various rosin derivatives.

Examples of the petroleum tackifier resin include known petroleum resin such as aromatic petroleum resin, aliphatic petroleum resin, alicyclic petroleum resin (aliphatic cyclic petroleum resin), aliphatic or aromatic petroleum resin, aliphatic or alicyclic petroleum resin, hyrogenated petroleum resin, coumarone resin, and coumarone indene resin. Specifically, the aromatic petroleum resin may be a polymer including one or two or more of vinyl-group containing aromatic hydrocarbon having carbon number of 8 to 10 (styrene, o-vinyl toluene, m-vinyl toluene, p-vinyl toluene, α-methylstyrene, β-methylstyrene, indene, methylindene). The aromatic petroleum resin (so-called “C9 petroleum resin”) obtained from a fraction of vinyl toluene or indene (so-called “C9 petroleum fraction”) is preferably used. Examples of the aliphatic petroleum resin include a polymer including one or two or more of olefin having carbon number of 4 to 5 (such as butane-1, isobutylene, pentene-1) and diene having carbon number of 4 to 5 (such as butadiene, piperilene (1,3-pentadiene), isoprene). The aliphatic petroleum resin (so-called “C4 petroleum resin” or “C5 petroleum resin”) obtained from a fraction of butadiene, piperilene and isoprene (so-called “C4 petroleum fraction” or “C5 petroleum fraction”) is preferably used. Examples of the alicyclic petroleum resin may be alicyclic hydrocarbon resin, a polymer or a hydrogenated material of a cyclic diene compound, the aromatic hydrocarbon resin, and alicyclic hydrocarbon resin obtained by hydrogenating aromatic ring of aliphatic or aromatic petroleum resin described below. The aliphatic petroleum resin (so-called “C4 petroleum resin” or “C5 petroleum resin”) is made into a cyclic dimer and polymerized to produce the alicyclic hydrocarbon resin. Examples of the cyclic diene compound include cyclopentadiene, dicyclopentadiene, ethylidene norbornene, dipentene, ethylidene bicycloheptene, vinyl cycloheptene, tetrahydroindene, vinylcyclohexene, and limonene. The aliphatic or aromatic petroleum resin may be a styrene-olefin copolymer. So-called “C5/C9 copolymer petroleum resin” is used as the aliphatic or aromatic petroleum resin.

The tackifier resin on the market is used and trade mark “SUMILITE resin PR-12603” supplied by SUMITOMO BAKELITE CO., LTD. and trade name “PENSEL D125” supplied by ARAKAWA CHEMICAL INDUSTRIES, LTD. may be used.

The content of the tackifier resin in the adhesive composition is not limited. The content amount of the tackifier resin in the acrylic pressure-sensitive adhesive layer may be from 5 to 100 parts by mass in the total amount of the monomer component (100 parts by mass) constituting the acrylic polymer, and more preferably from 10 to 50 parts by mass. If the content amount of the tackifier resin is greater than 100 parts by mass, the adhesive properties may not be improved even if the tackifier resin is added further. If the content amount of the tackifier resin is less than 5 parts by mass, the added tackifier may not have the effects.

The adhesive composition may further contain known additives such as crosslinking promoters, age inhibitors, fillers, colorants (pigments or dyestuffs), ultraviolet absorbers, antioxidants, chain-transfer agents, plasticizers, softeners, surfactants, and antistatic agents, and solvents (solvent usable in the solution polymerization of the acrylic polymer) according to necessity.

The adhesive composition may be prepared by mixing acrylic polymer (or acrylic polymer solution), a crosslinking agent, a tackifier, a solvent or other additives.

Though not critical, the pressure-sensitive adhesive layer has a thickness of preferably 10 μm to 120 μm, and more preferably 13 μm to 90 μm. The pressure-sensitive adhesive layer having such a thickness is effective for forming the terminal portions.

A process of forming the pressure-sensitive adhesive layer is not limited. For example, the adhesive composition may be coated over a metal foil and dried and/or cured according to necessity.

The coating in the process of forming the pressure-sensitive adhesive layer may employ a known coating technique and may use any of known coaters. Examples of the coaters include a gravure roll coater, a reverse roll coater, a kiss roll coater, a dip roll coater, a bar coater, a knife coater, a spray coater, a comma coater and a direct coater.

The electroconductive composite layer may further include any of other layers (for example, an intermediate layer or an under coat layer) in addition to the metal foil and the pressure-sensitive adhesive layer as long as the object of the present invention is not hindered.

Though not critical, the thickness of the electroconductive composite layer is preferably from 25 μm to 250 μm, and more preferably from 4 μm to 140 μm. The electroconductive composite layer having such a thickness improves workability. The thickness of the electroconductive composite layer is referred to as a thickness ranging from a surface of the metal foil to the adhesive surface (an attachment surface).

Though not limited, the electroconductive composite layer may be produced by forming a pressure-sensitive adhesive layer on one surface of the metal foil and subsequently exposing multiple points of the metal foil from the surface of the pressure-sensitive adhesive layer through bottomless drawing to form terminals. Specifically, the electroconductive composite layer may be produced typically by the methods described in Japanese Examined Utility Model Registration Publication No. S63-46980 and Japanese Unexamined Patent Application Publication No. H08-185714.

An example of such production methods will be described below. Initially, coating liquid (an adhesive composition) including the acrylic polymer and any of solvents, crosslinking agents, tackifier resin and other additives according to the necessity is coated over a surface of the metal foil 4 with a desired thickness and dried and/or cured to form the attachment layer 5. The metal foil 4 is then drawn into a bottomless cylindrical shape using a punch-shaped positive die and a corresponding negative die. Next, the extremity of the cylindrical portion is bent outward horizontally by pressing to form a flange-shaped terminal 6. Thus, the electroconductive composite layer 3 is produced.

In general, a plurality of terminals 6 are formed at a suitable spacing as typically in the scatter pattern illustrated in FIG. 3. The electroconductive composite layer 3 may further include an auxiliary sheet or an auxiliary tape as described in Japanese Unexamined Patent Application Publication Nos. H08-185714, H10-292155, and H11-302615 to provide good moisture-proof properties and stable electrically conductivity.

A method of producing the terminals 6 in the electroconductive composite layer 3 may include a method of embossing the electroconductive composite layer 3 from a metal foil side other than the drawing method and the pressing method. Accordingly, as illustrated in FIG. 4, the terminals 16 are formed so that a part of the metal foil (the electroconductive support substrate layer) 14 is through the pressure-sensitive adhesive layer (the electroconductive attachment layer) 15. Thus, the electroconductive composite layer 13 having such terminals 16 is produced.

According to another embodiment, as illustrated in FIG. 5, an electroconductive composite layer 23 may include an electroconductive non-woven cloth or a metal foil as an electroconductive substrate layer 24 and an electroconductive pressure-sensitive adhesive layer as the electroconductive attachment layer 25.

An electroconductive pressure-sensitive adhesive layer constituting the electroconductive attachment layer 25 includes the pressure-sensitive adhesive layer as the electroconductive attachment layer 5, 15 containing electroconductive fillers. The pressure-sensitive adhesive layer as the electroconductive attachment layer 25 is preferably an acrylic pressure-sensitive adhesive layer.

The electroconductive filler may be any of known or customary ones, which are typified by fillers made from metals such as nickels, iron, chromium, cobalt, aluminum, antimony, molybdenum, copper, silver, platinum, and gold, alloys or oxides of these metals, and carbon materials such as carbon black; and fillers including, for example, polymer beads or resins coated with these. Among them, metal fillers and/or metal-coated fillers are preferred.

The electroconductive filler is not limited in its shape but preferably has a spheroidal and/or spike-like shape, and more preferably has a spheroidal shape. A spheroidal and/spike-like electroconductive filler, when used, is readily dispersible in the pressure-sensitive adhesive layer and ma allow the pressure-sensitive adhesive tape to have both a suitable tackiness and satisfactory electrical conductivity. A filament-like, flake-like, or resinoid filler may have poor dispersibility to form coarse aggregates or may be aligned in the pressure-sensitive adhesive layer in a direction in parallel with the attachment surface to impede sufficient electrical conductivity in the thickness direction of the pressure-sensitive adhesive layer. This may cause the pressure-sensitive adhesive layer to fail to have both a suitable tackiness and satisfactory electrical conductivity and may cause the pressure-sensitive adhesive layer to have a poor appearance. Though not critical, the electroconductive filler has an aspect ratio of preferably from 1.0 to 2.0, and more preferably from 1.0 to 1.5. The aspect ratio may be measured typically with a scanning electron microscope (SEM).

The content of the electroconductive filler in the pressure-sensitive adhesive layer is preferably from 10 to 500 parts by mass, and more preferably from 20 to 400 parts by mass, relative to the total amount (100 parts by mass) of the resin component(s) in the pressure-sensitive adhesive layer (the total amount of monomer component(s) constituting the acrylic polymer in the acrylic pressure-sensitive adhesive layer). The electroconductive filler, if contained within the above range, may not aggregate with each other or may not cause a rough adhesive face, may not invite insufficient tackiness and/or poor appearance and may not cause insufficient electric conductivity.

The adhesive composition for the formation of the pressure-sensitive adhesive layer may employ any of known additives according to necessity within ranges not adversely affecting the characteristic properties obtained according to the present invention. Exemplary additives include crosslinking agents, cross-linking promotors, tackifier resins (e.g., rosin derivatives, polyterpene resins, petroleum resins, and oil-soluble phenols), age inhibitors, fillers, colorants (e.g., pigments and dyestuffs), ultraviolet absorbers, antioxidants, chain-transfer agents, plasticizers, softeners, surfactants, and antistatic agents. The formation of the pressure-sensitive adhesive layer may employ any of regular solvents.

(Electroconductive Intermediate Layer)

The electroconductive intermediate layer 7 is between the electrocondcutive resin foam layer 2 and the electroconductive composite layer 3 to electrically connect the electrocondcutive resin foam layer 2 and the electroconductive composite layer 3.

The electroconductive intermediate layer 7 has two attachment surfaces and has a laminated configuration like a double-sided tape. One of the attachment surfaces of the electroconductive intermediate layer 7 is attached to the electroconductive resin foam layer and another one of the attachment surfaces is attached to the electroconuctive base layer 4 of the electroconductive composite layer 3.

The electroconductive intermediate layer 7 may include a single layer or two or more layers as long as it does not hinder the object of the present invention. The electroconductive intermediate layer 7 preferably includes a single layer because the thickness of the entire electroconductive pressure-sensitive adhesive cushioning member is reduced.

The single-layered electroconductive intermediate layer 7 includes an electroconductive pressure-sensitive adhesive layer containing the electroconductive fillers in the adhesive layer. Examples of the electroconductive pressure-sensitive adhesive layer (such as a pressure-sensitive adhesive layer, an electrodconductive filler) are the ones used for the electroconductive attachment layer 25 of the electroconductive composite layer 23. Similar to the electroconductive attachment layer 25, the acrylic pressure-sensitive adhesive layer containing the electroconductive fillers is preferred as the electroconductive pressure-sensitive adhesive layer.

The electroconductive intermediate layer 7 has a thickness (lower limit) of preferably 1 μm or more, more preferably 5 μm or more, and further more preferably 10 μm or more. Also, the electroconductive intermediate layer 7 has a thickness (upper limit) of preferably 300 μm or less, more preferably 200 μm or less, and further more preferably 100 μm or less.

The content of the electroconductive filler in the electroconductive intermediate layer 7 is preferably from 10 to 500 parts by mass, and more preferably from 20 to 400 parts by mass, relative to the total amount (100 parts by mass) of the resin component(s) in the electroconductive intermediate layer 7 (the total amount of monomer component(s) constituting the acrylic polymer in the acrylic pressure-sensitive adhesive layer). The electroconductive filler, if contained within the above range, may not aggregate with each other or may not cause a rough adhesive face, may not invite insufficient tackiness and/or poor appearance and may not cause insufficient electric conductivity.

The electroconductive intermediate layer 7 has a volume resistivity of 1×10¹⁰ Ω·cm or less, and preferably 1×10⁸ Ω·cm or less, and more preferably 1×10⁵ Ω·cm or less. The volume resistivity of the electroconductive intermediate layer 7 may be measured according to the double ring electrode method prescribed in Japanese Industrial Standards (JIS) K6271.

Known methods of double-side pressure-sensitive adhesive sheets may be used as a method of producing the electroconductive intermediate layer 7.

(Release Liner)

The release liner 8 may be provided on a surface of the electroconductive pressure-sensitive adhesive cushioning member 1 before use to protect the attachment surface 5a of the electroconductive attachment layer 5 included in the electroconductive composite layer 3. Such a release liner is not limited but may be selected from known release liners.

The release liner may be made of a plastic film having high releasing properties or may include a release liner substrate and a release treatment layer on one side or two sides of the release liner substrate. Examples of a plastic film having high releasing properties include a polyolefin film made of polyolefin resin such as ethylene-α-olefin copolymer (block copolymer or random copolymer) such as polyethylene (low density polyethylene, linear low density polyethylene), polypropylene, ethylene-propylene copolymer, as well as a mixture of the above; and a fluororesin film. The release liner preferably includes the substrate and the release treatment layer thereon.

A plastic film is preferably used as a releasing liner substrate. Materials other than plastic film such as papers (such as Japanese papers, foreign papers, glassine papers), non-woven cloths or cloths, foam members, metal foils, a composite base material made of various substrates (e.g., metal deposited plastic film) may be used for the releasing liner substrate. A thickness of the release liner substrate is selectively determined according to an object, and is generally from 10 μm to 500 μm. Examples of the plastic film for use in the release liner substrate include films made of polyester such as polyethylene terephthalate; polyolefin such as polypropylene, polyethylene, ethylene-propylene copolymer; polyvinyl chloride; polyimide; and thermoplastic resin such as polycarbonate. The plastic film may be an unstretched film or a stretched (uniaxially stretched or biaxially stretched) film.

The release treatment layer is formed with general release treatment agents for forming a release treatment layer of a release liner (such as silicone release treatment agents, fluorine-based release treatment agents, long-chained alkyl release treatment agents). The release treatment layer may be formed by providing a release film such as a polyolefin film made of polyolefin resin including ethylene-α-olefin copolymer such as polyethylene, polypropylene, ethylene-propylene copolymer; and a fluororesin film on the release liner substrate with laminating or coating. The release treatment layer may be provided on one face or two faces of the release liner substrate of the release liner.

(Method of Producing Electroconductive Pressure-Sensitive Adhesive Cushioning Member)

Each of the electroconductive resin foam layer, the electroconductive intermediate layer, and the electroconductive composite layer is independently produced and they are bonded together to produce an electroconductive pressure-sensitive adhesive cushioning member.

(Properties of Electroconductive Pressure-Sensitive Adhesive Cushioning Member)

The electroconductive pressure-sensitive adhesive cushioning member is excellent in electromagnetic shielding properties and cushioning properties (pressure buffering properties, shock absorbing properties). The electroconductive pressure-sensitive adhesive cushioning member is excellent in sealing properties, dustproofing properties, flexibility, and conformability to surface asperities.

(Usage of Electroconductive Pressure-Sensitive Adhesive Cushioning Member)

The electroconductive pressure-sensitive adhesive cushioning member is usable in various devices such as a display device. The electroconductive pressure-sensitive adhesive cushioning member is preferably used in a display device including an electrostatic capacitance touch panel.

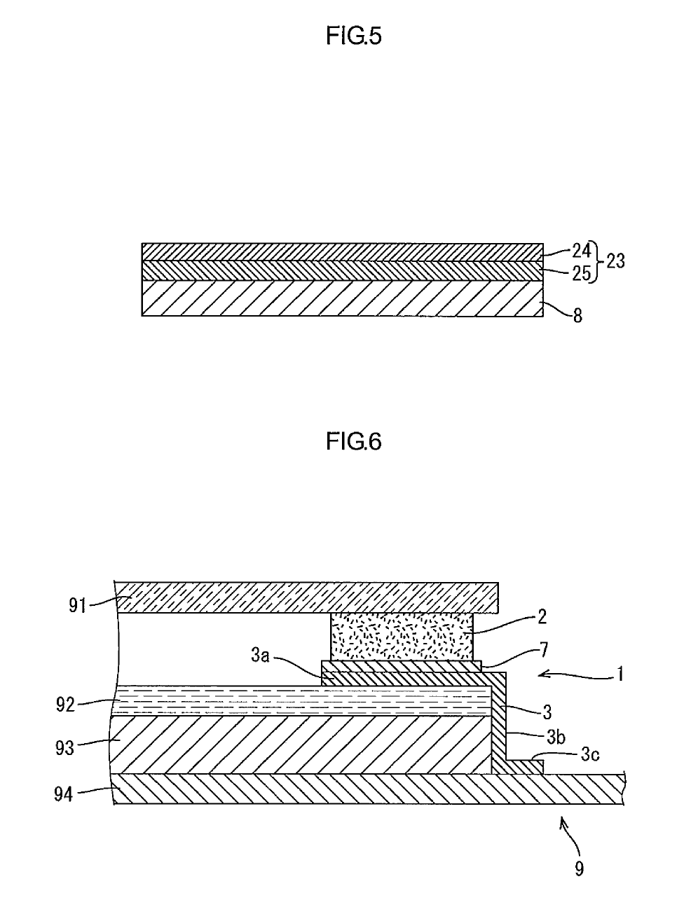

FIG. 6 is a cross-sectional view typically illustrating a general configuration of a liquid crystal display device 9 including the electroconductive pressure-sensitive adhesive cushioning member 1. The liquid crystal display device 9 includes an electrostatic capacitance touch panel 91, a liquid crystal panel 92, a backlight unit 93, and a metal chassis 94. The liquid crystal display device 9 may be included in a car navigation system. The chassis 94 has a plate-like shape, and the backlight unit 93 and the liquid crystal display panel 92 are disposed on the chassis 94 in this order. The electroconductive pressure-sensitive adhesive cushioning member 1 is attached to a surface of the liquid crystal display panel 92. An edge portion of the touch panel 91 is disposed on the electroconductive resin foam layer 2 of the electroconductive pressure-sensitive adhesive cushioning member 1. The electroconductive pressure-sensitive adhesive cushioning member 1 is sandwiched between the touch panel 91 and the liquid crystal display panel 92.

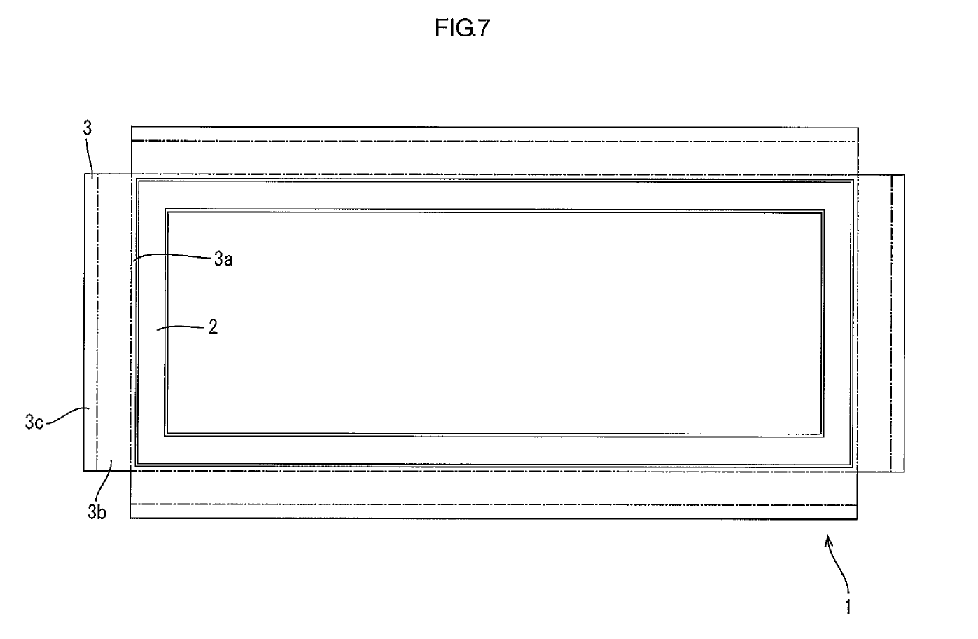

FIG. 7 is a plan view of the electroconductive pressure-sensitive adhesive cushioning member 1 included in the liquid crystal display device 9. As illustrated in FIG. 7, the electroconductive pressure-sensitive adhesive cushioning member 1 has a frame-like shape that surrounds an outer edge of the liquid crystal panel 92 from a front-surface side. In the electroconductive pressure-sensitive adhesive cushioning member 1, the electroconductive composite layer 3 projects outwardly from the electroconductive resin foam layer 2 and the electroconductive intermediate layer 7. Namely, a part of the electroconductive composite layer 3 projects from the electroconductive resin foam layer 2 and the electroconductive intermediate layer 7.

The electroconductive composite layer 3 includes a first portion 3a, a second portion 3b, and a third portion 3c. The first portion 3a is attached to a front surface of the liquid crystal panel 92. The second portion 3b is attached to an edge surface of the liquid crystal display panel 92 and an edge surface of the backlight unit 93. The third portion 3c is attached to a front surface of the chassis 94. The first portion 3a of the electroconductive composite layer 3 has a frame-like shape having a rectangular shape as a whole. As illustrated in FIG. 7, the second portion 3b and the third portion 3c of the electroconductive composite layer 3 extend outwardly in four directions from the rectangular first portion 3a. The electroconductive composite layer 3 is bent according to a shape of the adherend.

In the liquid crystal display device 9, if a user touches the touch panel 91 with his/her finger, a portion of the touch panel 91 is pressed toward the liquid crystal display panel 92. Accordingly, the electroconductive resin foam layer 2 is elastically deformed and compressed between the touch panel 91 and the liquid crystal display panel 92. If the user releases his/her finger from the touch panel 91, the electroconductive resin foam layer 2 is stretched and recovers.

Static electricity transferred from the finger of the user to the touch panel 91 is released to the chassis 94 through the electroconductive pressure-sensitive adhesive cushioning member 1. The electroconductive pressure-sensitive adhesive cushioning member 1 shields electromagnetic waves generated in the liquid crystal display device 9 and flying from an exterior.

An electroconductive pressure-sensitive adhesive cushioning member includes an electroconductive resin foam layer, an electroconductive composite layer including an electroconductive base layer and an electroconductive attachment layer disposed on a surface of the electroconductive base layer and having an attachment surface to be attached to an obstacle, and an electroconductive intermediate layer disposed between the electroconductive resin foam layer and the electroconductive composite layer.

In the electroconductive pressure-sensitive adhesive cushioning member, the electroconductive base layer may be made of an electroconductive non-woven cloth or a metal foil.

In the electroconductive pressure-sensitive adhesive cushioning member, the electroconductive base layer may be made of a metal foil, the electroconductive attachment layer may be a pressure-sensitive adhesive layer disposed on a surface of the metal foil, and the electroconductive base layer may include a terminal portion that is formed of a part of the metal foil and is through the pressure-sensitive adhesive layer.

In the electroconductive pressure-sensitive adhesive cushioning member, the electroconductive intermediate layer may include an adhesive agent and an electroconductive filler.

In the electroconductive pressure-sensitive adhesive cushioning member, the electroconductive resin foam layer may have a volume resistivity of 10¹⁰ Ω·cm or less and a repulsive load of 5 N/cm² or less at 50% compression.

In the electroconductive pressure-sensitive adhesive cushioning member, the electroconductive resin foam layer may have a surface resistivity of 10¹⁰Ω per square or less.

In the electroconductive pressure-sensitive adhesive cushioning member, the electroconductive resin foam layer may have an expansion ratio of 9 times or more.

In the electroconductive pressure-sensitive adhesive cushioning member, the electroconductive resin foam layer may have an apparent density of from 0.01 g/cm³ to 0.15 g/cm³.

In the electroconductive pressure-sensitive adhesive cushioning member, the electroconductive resin foam layer may have an average cell diameter of from 10 μm to 250 μm.

In the electroconductive pressure-sensitive adhesive cushioning member, the electroconductive resin foam layer may be formed of a resin composition containing resin and an electroconductive material

In the electroconductive pressure-sensitive adhesive cushioning member, the electroconductive material may be carbonaceous filler.

In the electroconductive pressure-sensitive adhesive cushioning member, the resin may be thermoplastic resin.

In the electroconductive pressure-sensitive adhesive cushioning member, the electroconductive resin foam layer may include thermoplastic resin and carbonaceous filler, and the carbonaceous filler may have a BET specific surface area of 500 m²/g and may be present in an amount of 3 to 20 parts by mass per 100 parts by mass of the thermoplastic resin, and the electroconductive resin foam layer may have an average cell diameter of from 10 μm to 250 μm, and an apparent density of from 0.01 g/cm³ to 0.15 g/cm³.

In the electroconductive pressure-sensitive adhesive cushioning member, the electroconductive resin foam layer may have a closed cell structure or semiopen/semiclosed cell structure.

In the electroconductive pressure-sensitive adhesive cushioning member, the electroconductive resin foam layer may be formed via a process in which a resin composition including resin and an electroconductive material may be impregnated with a high-pressure inert gas and decompressed after impregnation of the high-pressure inert gas.

In the electroconductive pressure-sensitive adhesive cushioning member, the electroconductive resin foam layer may include a resin composition containing thermoplastic resin and carbonaceous filler, the resin composition in which the carbonaceous filler may have a BET specific surface area of 500 m²/g and may be present in an amount of 3 to 20 parts by mass per 100 parts by mass of the thermoplastic resin, and the electroconductive resin foam layer may be formed via a process in which the resin composition may be impregnated with a high-pressure inert gas and decompressed after impregnation of the high-pressure inert gas.

In the electroconductive pressure-sensitive adhesive cushioning member, inert gas may be carbon dioxide.

In the electroconductive pressure-sensitive adhesive cushioning member, inert gas may be in a supercritical state.

In the electroconductive pressure-sensitive adhesive cushioning member, the electroconductive composite layer may project outwardly from the electroconductive resin foam layer.

According to the present technology, an electroconductive cushioning member that is excellent in conductivity, an electromagnetic wave shielding property, and a cushioning property is provided.

### EXAMPLES

The present technology will be described in further detail with reference to several examples below. It should be noted, however, that these examples are never constructed to limit the scope of the present invention.

### Example 1

### Production Example of Electroconductive Resin Foam Layer

A mixture was prepared by mixing 50 parts by mass of polypropylene [a melt flow rate (MFR): 0.35 g/10 min], 50 parts by mass of polyolefin elastomer [a melt flow rate (MFR): 6 g/10 min, JIS A hardness: 79°], 10 parts by mass of magnesium hydroxide, 10 parts by mass of carbon [trade mark “KETJENBLACK EC-600JD” supplied by Ketjenblack International Co., hollow shell structure, BET specific surface area of 1270 m²/g], and 1 parts by mass of monoglyceride stearate with a biaxial kneader supplied by the Japan Steel Works, LTD. (JSW) at a temperature of 200° C. Then, the mixture was extruded into a strand shape and water cooled and molded into a pellet shape.

The pellet was put in a single-screw extruder supplied by the Japan Steel Works, LTD. and carbon dioxide gas was introduced therein under atmosphere of 220° C. and pressure of 13 MPa (12 MPa after the introduction of the gas). Carbon dioxide gas was introduced by 6.0 mass % based on the total amount of polymer. After carbon dioxide gas was sufficiently saturated, the pellet was cooled down to a temperature appropriate for foaming and extruded from the die and the foam was obtained. The foam was shaped into a desired shape to obtain an electroconductive resin foam layer having a thickness of 0.7 mm.

(Production Example of Electroconductive Composite Layer)

A monomer mixture was prepared by mixing 70 parts by mass of 2-ethylhexyl acrylate (2EHA), 30 parts by mass of n-butyl acrylate (BA), and 3 parts by mass of acrylic acid (AA). In a separable flask were placed 100 parts by mass of the monomer mixture, 0.2 parts by mass of 2,2′-azobisisobutyronitrile (AIBN) as a polymerization initiator, and 186 parts by mass of ethyl acetate as a polymerization solvent, followed by stirring for one hour while introducing nitrogen gas. After removing oxygen in the polymerization system in the above manner, the mixture was raised in temperature to 63° C., followed by a reaction for 10 hours. The reaction mixture was diluted with toluene to regulate its concentration, and thereby yielded an acrylic polymer solution having a solids concentration of 30 mass %. An acrylic polymer in the acrylic polymer solution had a weight-average molecular weight of 520,000.

An adhesive composition solution was prepared by adding a crosslinking agent “CORONATE L” (supplied by Nippon Polyurethane Industry Co., LTD., isocyanate crosslinking agent) to the acrylic polymer solution in an amount of 2 parts by mass per 100 parts by mass of the acrylic polymer. The blending quantity (added amount) of CORONATE L is indicated by the added amount in terms of solids content (parts by mass). The above-prepared adhesive composition solution was applied onto a 163-μm thick release paper (release liner) (“110EPS(P) Blue” supplied by Oji Paper Co., Ltd.) through flow casting so as to have a dry thickness of 40 μm, heated and dried at 120° C. under normal atmospheric pressure for five minutes, and thereby formed a pressure-sensitive adhesive layer.

Next, a 35-μm thick tough pitch copper foil was applied to the surface of the pressure-sensitive adhesive layer, followed by aging at 40° C. for one day. Next, a laminate having a structure of “(metal foil)/(pressure-sensitive adhesive layer)” was obtained by removing the release paper. The laminate was shaped using a press and a drawing die having spacings (pitches) “a” and “b” in FIG. 3 of each 5 mm, a punch outer diameter of 0.425 mm, and a die inner diameter of 0.5 mm. Thus, an electroconductive composite layer having terminals with the shapes illustrated in FIG. 1 was obtained.

In addition, a release liner was applied to the adhesive surface (an attachment surface) of the electroconductive composite layer. The release liner included a polyethylene film (80 μm thick), one surface of which had undergone a surface-release treatment.

(Production Example of Electroconductive Intermediate Layer)

A liquid monomer mixture (a monomer composition) was prepared by mixing 63 parts by mass of isooctylacrylate (iOA) and 7 parts by mass of acrylic acid (AA). As a photopolymerization initiator, 0.05 parts by mass of “IRGACURE 651 (2,2-dimethoxy-1,2-diphenylethane-1-one)” supplied by BASF Japan LTD.) and 0.05 parts by mass of “IRGACURE 184 (hydroxyl cyclohexyl phenyl ketone)” supplied by BASF Japan LTD.) were mixed with the liquid monomer mixture, followed by irradiation of ultraviolet rays until the viscosity was approximately 6.4 Pa·s (viscometer: VISCOMETER (model: BH) supplied by TOKIMEC). Thus, syrup (iOA/AA=9/1) containing a prepolymer obtained by partially polymerizing a part of the monomer component was obtained.

The syrup was mixed with 30 parts by mass of isooctylacrylate (iOA), 0.06 parts by mass of 1,6-hexanediol diacrylate (HDDA), 150 parts by mass of large conductive particles (“TP25S12” supplied by Potters-Ballotini Co., Ltd., silver-coated glass powder, a particle size of a maximum peak in a particle size distribution curve: 26 μm, a particle size range: 18 μm to 35 μm, a true density: 2.7 g/cm³) and 50 parts by mass of small conductive particles (“ES-6000-S7N” supplied by Potters-Ballotini Co., Ltd., silver-coated glass powder, a particle size of a maximum peak in a particle size distribution curve: 6 μm, a particle size range: 2 μm to 10 μm, a true density: 3.9 g/cm³). Then, the syrup was sufficiently mixed and an adhesive composition was obtained.

The obtained adhesive composition was coated over a release treatment surface of one release liner and a coating layer was formed on the one release liner. Another release liner was attached to the coating layer of the one release liner such that a release treatment surface of the other release liner is in contact with the coating layer. Thus, the one and other release liners were attached to each other with having the coating layer therebetween. As the release liner, a polyethylene terephthalate substrate (“MRE” 38 μm thick supplied by Mitsubishi Polyester Film Co., Ltd., “MRF” 38 μm thick supplied by Mitsubishi Polyester Film Co., Ltd.) was used.

Next, the coating layer were irradiated with ultraviolet rays having an illuminance of 5 mW/cm² from both surface sides for three minutes to cure the coating layer and obtain a pressure-sensitive adhesive layer (an electorconductive intermediate layer) of 50 μm thick. “Blacklight” supplied by TOSHIBA CORPORATION was used as a generator of ultraviolet rays. The illuminance of ultraviolet rays was adjusted by using an UV checker (“UVR-T1” supplied by TOPCON CORPORATION, maximum sensitivity; measured at 350 nm). Thus, an electroconductive intermediate layer having two surfaces that are protected by the release liners was obtained.

(Production Example of Electroconductive Pressure-Sensitive Adhesive Cushioning Member)

The release liner was removed from one of adhesive surfaces of the electroconductive intermediate layer and the exposed adhesive surface of the electroconductive intermediate layer was attached to the metal foil of the electroconductive composite layer. The release liner was removed from the other one of the adhesive surfaces of the electroconductive intermediate layer and the exposed adhesive surface of the electroconductive intermediate layer was attached to one surface of the electroconductive resin foam layer. Thus, an electroconductive pressure-sensitive adhesive cushioning member including the electroconductive resin foam layer, the electroconductive intermediate layer, and the electroconductive composite layer was produced.

### Example 2

An electroconductive pressure-sensitive adhesive cushioning member was produced by the procedure of Example 1, except for using an electroconductive resin foam layer having a 1.0 mm thick.

[Evaluation 1: Z-Axis Conductivity]

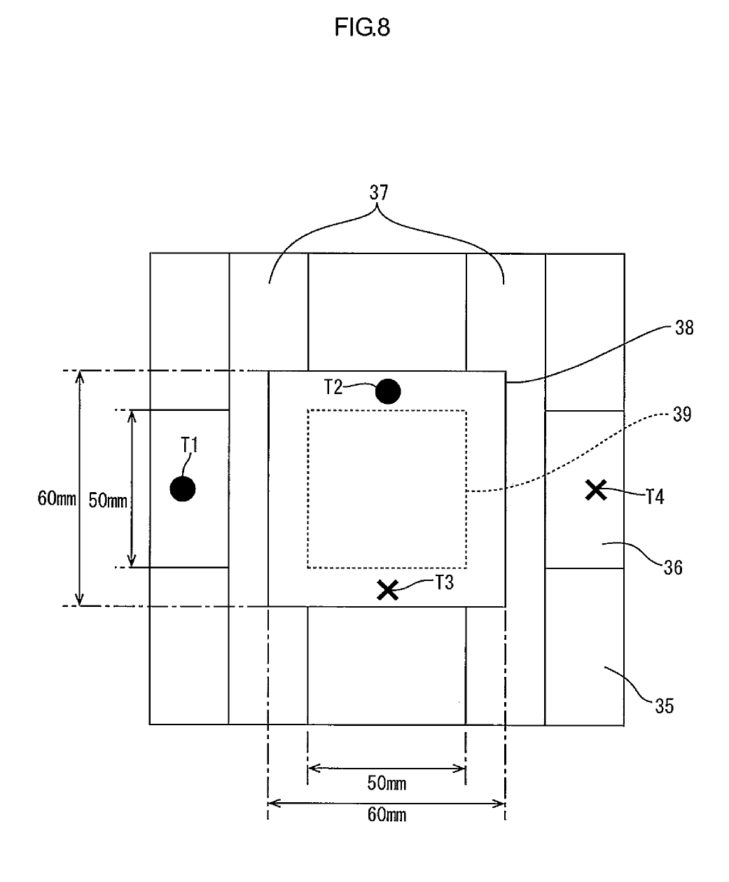

A piece having a size of 50 mm by 50 mm was cut from the electroconductive pressure-sensitive adhesive cushioning member obtained in the examples. A rolled copper foil (35 μm thick) was attached to a cut piece of the electroconductive pressure-sensitive adhesive cushioning member to yield a test sample. A copper foil (a rolled copper foil having 35 μm thick) 36 was placed on a glass plate (soda lime glass) 35 according to the arrangement in FIG. 8. An insulation tape 37 was put on the copper foil 36. The copper foil 36 and the test sample 38 were pressed with pressure of 5.0 N/cm by a hand roller (100 mm width) in a normal temperature atmosphere so that an area of a bonded portion 39 (surrounded by a dotted line in FIG. 8) was 25 cm². In FIG. 8, a vertical direction corresponds to a longitudinal direction of the test sample 38 and the test sample 38 was attached to the copper foil 36 so that the adhering surface of the test sample 38 was in contact with a surface of the copper foil 36. After the attachment, the test sample was left stand at normal temperature for 15 minutes. Then, copper foil terminals (represented by T1 and T2 in FIG. 8) were connected to terminals of a resistance meter (RM3544-01 supplied by HIOKI E.E. CORPORATION) and a resistance was measured with a load of 2 kg being applied to the bonded portion 39. The test results are described in Table 1.

[Evaluation 2: Impact Force Absorbing Efficiency]

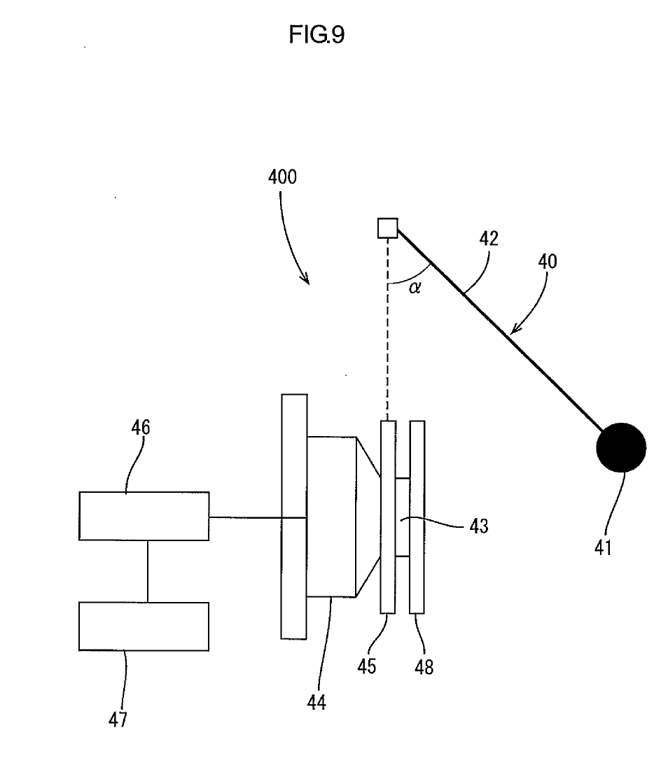

An impact force (F0) without using the electroconductive pressure-sensitive adhesive cushioning member obtained in the examples and an impact force (F1) with using the electroconductive pressure-sensitive adhesive cushioning member were measured with using a pendulum tester illustrated in FIG. 9 and impact force absorbing efficiency (%) was calculated according to a following equation.

Impact force absorbing efficiency (%)=(F0−F1)/F0×100

A pendulum tester 400 includes a pendulum 40, a force sensor 44 (supplied by TOYO Corporation), an aluminum plate 45, a power source 46, and Multi-Purpose FTT Analyzer 47 (supplied by ONO SOKKI). The pendulum 40 includes an impact element 41 of a steel ball having mass of 28 g (0.27N) and a support bar 42 having 350 mm length.

A test piece 43 having a size of 20 mm by 20 mm was cut from the electroconductive pressure-sensitive adhesive cushioning member obtained in the examples. The test piece 43 was attached to the aluminum plate 45 and an acrylic plate 48 of 1 mm thick was attached to another surface of the test piece 43. The force sensor 44 sensed an impact force upon impact of the impact element 41 to the acrylic plate 48 and the impact force was measured by Multi-Purpose FTT Analyzer 47. The pendulum 40 hit the acrylic plate 48 from a position having an impact angle α of approximately 45° that is made between the support bar 42 and a vertical line. The test results of impact force absorbing efficiency are described in Table 1.

By applying a load to the acrylic plate 48, the impact absorbing efficiency of each of the test pieces 43 having respective compression rates 30%, 50%, and 70% was obtained. The test results are described in Table 1.

TABLE 1

| | ELECTROCONDUCTIVE | | | | | | | | |
|---|---|---|---|---|---|---|---|---|---|
| | PRESSURE-SENSITIVE | | | | | | | | |
| | ADHESIVE CUSHIONING MEMBER | | | | | | | | |
| | ELECTRO- | ELECTRO- | ELECTRO- | | | | | | |
| | CONDUCTIVE | CONDUCTIVE | CONDUCTIVE | EVALUATION 1 | | EVALUATION 2 | | | |
| | RESIN FOAM | INTERMEDIATE | COMPOSITE | Z-AXIS | | IMPACT ABSORBING EFFICIENCY (%) | | | |
| | LAYER | LAYER | LAYER | RESIS- | Z-AXIS | COM- | COM- | COM- | COM- |
| | THICKNESS | THICKNESS | THICKNESS | TANCE | CONDUC- | PRESSION | PRESSION | PRESSION | PRESSION |
| | (mm) | (mm) | (mm) | (Ω) | TIVITY | RATE 0% | RATE 30% | RATE 50% | RATE 70% |
| EX. 1 | 0.7 | 0.05 | 0.105 | 10000 | EXCELLENT | 70.3 | 70.8 | 67.9 | 64.2 |
| EX. 2 | 1.0 | 0.05 | 0.105 | 60000 | EXCELLENT | 70.8 | 75.4 | 72.4 | 65.6 |

As described in Table 1, it was confirmed that the electroconductive pressure-sensitive adhesive cushioning members of Examples 1 and 2 were excellent in the conductivity (electromagnetic wave shielding properties) and cushioning properties (impact absorbing properties).

The conductivity (Z-axis conductivity) of the electroconductive pressure-sensitive adhesive cushioning member was determined excellent if the resistance (Ω) of the electroconductive pressure-sensitive adhesive cushioning member in the thickness direction was 1×10⁶ or less.

The impact absorbing property of the electroconductive pressure-sensitive adhesive cushioning member was determined excellent if the impact absorbing efficiency (%) was 60% or more.

1. An electroconductive pressure-sensitive adhesive cushioning member comprising:
an electroconductive resin foam layer;
an electroconductive composite layer including an electroconductive base layer and an electroconductive attachment layer, the electrocoductive attachment layer being disposed on a surface of the electroconductive base layer and having an attachment surface to be attached to an obstacle; and
an electroconductive intermediate layer disposed between the electroconductive resin foam layer and the electroconductive composite layer.

2. The electroconductive pressure-sensitive adhesive cushioning member according to claim 1, wherein the electroconductive base layer included in the electrocouductive composite layer is made of an electroconductive non-woven cloth or a metal foil.

3. The electroconductive pressure-sensitive adhesive cushioning member according to claim 1, wherein
the electroconductive base layer is made of a metal foil,
the electroconductive attachment layer is a pressure-sensitive adhesive layer disposed on a surface of the metal foil, and
the electroconductive base layer includes a terminal portion that is formed of a part of the metal foil and is through the pressure-sensitive adhesive layer.

4. The electroconductive pressure-sensitive adhesive cushioning member according to claim 1, wherein the electroconductive intermediate layer includes an adhesive agent and electroconductive filler.

5. The electroconductive pressure-sensitive adhesive cushioning member according to claim 1, wherein the electroconductive resin foam layer has a volume resistivity of 10¹⁰ Ω·cm or less and a repulsive load of 5 N/cm² or less at 50% compression.

6. The electroconductive pressure-sensitive adhesive cushioning member according to claim 1, wherein the electroconductive resin foam layer has a surface resistivity of 10¹⁰Ω per square or less.

7. The electroconductive pressure-sensitive adhesive cushioning member according to claim 1, wherein the electroconductive resin foam layer has an expansion ratio of 9 times or more.

8. The electroconductive pressure-sensitive adhesive cushioning member according to claim 1, wherein the electroconductive resin foam layer has an apparent density of from 0.01 g/cm³ to 0.15 g/cm³.

9. The electroconductive pressure-sensitive adhesive cushioning member according to claim 1, wherein the electroconductive resin foam layer has an average cell diameter of from 10 μm to 250 μm.

10. The electroconductive pressure-sensitive adhesive cushioning member according to claim 1, wherein the electroconductive resin foam layer is formed of a resin composition containing resin and an electroconductive material

11. The electroconductive pressure-sensitive adhesive cushioning member according to claim 10, wherein the electroconductive material is carbonaceous filler.

12. The electroconductive pressure-sensitive adhesive cushioning member according to claim 10, wherein the resin is thermoplastic resin.

13. The electroconductive pressure-sensitive adhesive cushioning member according to claim 1, wherein
the electroconductive resin foam layer includes thermoplastic resin and carbonaceous filler,
the carbonaceous filler has a BET specific surface area of 500 m²/g and is present in an amount of 3 to 20 parts by mass per 100 parts by mass of the thermoplastic resin, and
the electroconductive resin foam layer has an average cell diameter of from 10 μm to 250 μm, and an apparent density of from 0.01 g/cm³ to 0.15 g/cm³.

14. The electroconductive pressure-sensitive adhesive cushioning member according to claim 1, wherein the electroconductive resin foam layer has a closed cell structure or semiopen/semiclosed cell structure.

15. The electroconductive pressure-sensitive adhesive cushioning member according to claim 1, wherein the electroconductive resin foam layer is formed via a process in which a resin composition including resin and an electroconductive material is impregnated with a high-pressure inert gas and decompressed after impregnation of the high-pressure inert gas.

16. The electroconductive pressure-sensitive adhesive cushioning member according to claim 1, wherein
the electroconductive resin foam layer includes a resin composition containing thermoplastic resin and carbonaceous filler, the resin composition in which the carbonaceous filler has a BET specific surface area of 500 m²/g and is present in an amount of 3 to 20 parts by mass per 100 parts by mass of the thermoplastic resin, and
the electroconductive resin foam layer is formed via a process in which the resin composition is impregnated with a high-pressure inert gas and decompressed after impregnation of the high-pressure inert gas.

17. The electroconductive pressure-sensitive adhesive cushioning member according to claim 15, wherein inert gas is carbon dioxide.

18. The electroconductive pressure-sensitive adhesive cushioning member according to claim 15, wherein inert gas is in a supercritical state.

19. The electroconductive pressure-sensitive adhesive cushioning member according to claim 1, wherein the electroconductive composite layer projects outwardly from the electroconductive resin foam layer.
